(19) United States
(12) Patent Application Publication
(10) Pub. No.: US 2021/0289808 A1
(43) Pub. Date: Sep. 23, 2021

(54) PROCESSED PRODUCT OF TEA IN THE FORM OF PARTICLES

(71) Applicant: AMOREPACIFIC CORPORATION, Seoul (KR)

(72) Inventors: Kwanghyun SHIN, Yongin-si (KR); Minjung KWON, Yongin-si (KR); Wonkyung CHO, Yongin-si (KR)

(73) Assignee: AMOREPACIFIC CORPORATION, Seoul (KR)

(21) Appl. No.: 17/204,741

(22) Filed: Mar. 17, 2021

(30) Foreign Application Priority Data
Mar. 18, 2020 (KR) 10-2020-0033242
Mar. 18, 2020 (KR) 10-2020-0033243

(51) Int. Cl. A23F 3/30; A23L 33/17

(52) U.S. Cl. CPC A23F 3/30; A23V 2002/00; A23L 33/17

(57) ABSTRACT

Disclosed are a processed product of tea in the form of particles and method for masking the bad taste or bad odor of collagen. In an aspect, the processed product of tea contains tea powder and collagen powder and does not contain a binder. In another aspect, the processed product of tea contains tea powder and collagen powder, and contains 10 wt % or less of fine powder having a particle diameter of 75 μm or smaller based on the total particle weight of the processed product of tea.

### TECHNICAL FIELD

### Cross-Reference to Related Application

This application claims the priority of Korean Patent Application No. 10-2020-0033242 filed on Mar. 18, 2020 and Korean Patent Application No. 10-2020-0033243 filed on Mar. 18, 2020, the contents of which in their entirety are herein incorporated by reference.

The present disclosure discloses a processed product of tea in the form of particles and a method for masking the bad taste or bad odor of collagen.

### BACKGROUND ART

When green tea is brewed with water, only the water-soluble ingredients contained in green tea are ingested and the remainder is discarded. In contrast, green tea powder is advantageous in that all the ingredients of green tea, e.g., tocopherols, vitamin A, dietary fiber, etc., can be ingested. Accordingly, the green tea powder allows ingestion of much more useful ingredients as compared to tea leaves brewed in hot water. However, tea utensils are necessary to drink green tea in powder form and long time is required because of decreased dispersibility owing to interparticle aggregation.

Recently, many tea products packaged in disposable sticks, which allow drinking of green tea by adding green tea powder to a water bottle or tumbler, are available. However, they are inconvenient in that, since the powder is not easily dispersed in water, they have to be shaken for a considerable time before drinking. In addition, for stick-type products in which green tea powder is packaged in small amounts, it is not easy to add a fixed quantity of the green tea powder due to low fluidity owing to interparticle aggregation and it is highly likely that problem may occur during sealing due to fine powder.

Collagen is a protein present in the bone, cartilage and skin of animals, and is known to be effective in improving skin elasticity and moisturization. Collagen-containing products are prepared from materials extracted from pig skin, cow skin, fish, etc. They have the problem that they are not easy to ingest due to the characteristic bad taste and bad odor of collagen. Accordingly, it is necessary to mask the bad taste and bad odor of collagen. Although the currently commercially available collagen-containing products contain flavoring substances with strong flavor or sweeteners with strong sweet taste in order to reduce the characteristic bad taste and bad odor of collagen, they disadvantageously increase the calorie of the products. In addition, there is a problem that the bad taste and bad odor of collagen remains even after ingestion.

### DISCLOSURE

### Technical Problem

In an aspect, the present disclosure is directed to providing a processed product of tea in the form of particles, which is quickly wetted and dispersed in water.

In another aspect, the present disclosure is directed to providing a processed product of tea in the form of particles, which contains collagen powder and improves the bad taste or bad odor of collagen.

In another aspect, the present disclosure is directed to providing a method for masking the bad taste or bad odor of collagen.

### Technical Solution

In an aspect, the present disclosure provides a processed product of tea in the form of particles, which contains tea powder and collagen powder and not contains a binder.

In another aspect, the present disclosure provides a processed product of tea in the form of particles, which contains tea powder and collagen powder, wherein 10 wt % or less of fine powder is contained based on the total particle weight of the processed product of tea, and the fine powder has a particle diameter of 75 μm or smaller.

### Advantageous Effects

In an aspect, the present disclosure provides a processed product of tea in the form of particles, which is quickly wetted and dispersed in water.

The processed product of tea according to the present disclosure is convenient to drink because it is quickly wetted and dispersed in water and is easy to package and use due to superior flowability owing to a small angle of repose.

In another aspect, the present disclosure provides a processed product of tea in the form of particles, which contains collagen powder, wherein the bad taste or bad odor of collagen are improved.

Conventionally, various additives such as flavors, sugars, synthetic polymers, etc. have been used to reduce the bad taste or bad odor of collagen, which can be represented as fishy taste or fishy odor. The technology disclosed in the present disclosure can achieve an effect of reducing and/or improving the bad taste or bad odor of collagen only with the tea powder, which is a natural substance.

In another aspect, the present disclosure provides a method for masking the bad taste or bad odor of collagen.

### BRIEF DESCRIPTION OF DRAWINGS

FIG. 1 shows the initial wetted state of a processed product of tea of Example 1 after measurement of wetting time in a test example.

FIG. 2 shows a result of, after measurement of the wetting time of a processed product of tea of Example 1, redispersing the processed product of tea by stirring once after it settled down in water and investigating redispersibility in a test example.

FIG. 3 shows the initial wetted state of a processed product of tea of Comparative Example 1 after measurement of wetting time in a test example.

FIG. 4 shows a result of adding microcrystalline cellulose to a beaker and observing its dispersed state 20 seconds later in a test example.

### BEST MODE

Hereinafter, the present disclosure is described in detail.

In an aspect, the present disclosure provides a processed product of tea in the form of particles, which contains tea powder and collagen powder, and not contains a binder.

In another aspect, the present disclosure provides a processed product of tea in the form of particles, which contains tea powder and collagen powder, wherein 10 wt % or less of fine powder is contained based on the total particle weight of the processed product of tea, and the fine powder has a particle diameter of 75 μm or smaller.

In an exemplary embodiment, the processed product of tea in the form of particles may be one in which the bad taste or bad odor of collagen is improved.

In an exemplary embodiment, the processed product of tea in the form of particles may not contain a sweetener.

In another aspect, the present disclosure provides a composition for masking the bad taste or bad odor of collagen, which contains tea powder as an active ingredient.

In another aspect, the present disclosure provides a use of tea powder for masking the bad taste or bad odor of collagen.

In another aspect, the present disclosure provides a use of tea powder in manufacturing a composition for masking the bad taste or bad odor of collagen.

In another aspect, the present disclosure provides a method for masking the bad taste or bad odor of collagen, which includes a step of mixing tea powder and collagen powder.

The existing green tea powder is not dispersed well in water when mixed in water for drinking due to interparticle aggregation and has low fluidity and flowability. In contrast, the processed product of tea according to the present disclosure, which is mixed with collagen powder, exhibits remarkably improved dispersion rate in solvents, e.g., water, as well as improved fluidity and flowability.

In the present disclosure, the binder refers to a substance which aggregates or binds powder. It forms large particles from powder by aggregating or binding the powder. For example, the binder may be a substance which aggregates or binds tea powder and may maintain form of the particles formed from the aggregation or binding of the tea powder. Examples of the binder may include starch, hydroxypropyl cellulose, hydroxyethyl cellulose, hydroxypropylmethyl cellulose, sucrose, dextrose, maltitol, maltodextrin, corn syrup, polyvinylpyrrolidone, polyvinyl alcohol, polysaccharides, gelatin, etc.

In the present disclosure, the processed product of tea in the form of particles refers to a processed product of tea which is in the form of particles. In an exemplary embodiment, the processed product of tea may be in the form of tea-collagen complex particles formed from aggregation of a plurality of tea powders and a plurality of collagen powders. For example, the processed product of tea may include tea-collagen complex particles formed from aggregation of a plurality of tea powders and a plurality of collagen powders by adding water to tea powder and collagen powder. When water is added to dried fine powder, the powder ingredients become sticky and aggregated with each other to form large particles which are about 10-150 larger than the original powder. The dried product of these particles may be called fine granules or granules. Usually, powder is prepared into fine granules or granules for enhancement of flowability, improvement of preservability, etc.

In an exemplary embodiment, the particle may have amorphous, spherical or oval shapes.

In the present disclosure, the tea powder refers to a powder obtained from tea tree (Camellia sinensis) as a raw material. For example, it may be a powder obtained by pulverizing, crushing or grinding the leaf of tea tree or a powder obtained by preparing an extract or extract solution of tea tree leaf into powder through spray drying, etc. The tea tree leaf is not limited in harvest time, presence or absence of processing, processing method, etc.

In an exemplary embodiment, the tea powder may be obtained using a pulverization device. The pulverization device may be largely classified into a crusher, a grinder, etc. The crusher is a device which pulverizes large solid lumps, and examples include a jaw crusher, a gyratory crusher, etc. The grinder is a device which prepares a powder primarily pulverized by a crusher into smaller pulverization products or prepares fine powder without primary pulverization, and examples include a hammer mill, a roller mill, a ball mill, an attrition mill, an air-flow type mill, etc. For preparation of tea tree leaf into powder, a pulverization device, particularly, an electric mill, a ball mill, a hammer mill, etc., is used.

In an exemplary embodiment, the tea may be tea leaf.

In an exemplary embodiment, the tea may be one or more selected from a group including unfermented tea, e.g., green tea, etc., fermented tea, e.g., black tea, etc., semi-fermented tea, e.g., oolong tea, white tea, flowering tea, etc., and post-fermented tea, e.g., puer tea, yellow tea, etc.

In an exemplary embodiment, the tea may be green tea.

In an exemplary embodiment, the tea may be green tea leaf.

In the present disclosure, the particle diameter may refer to the longest diameter of a particle. In another aspect, in the present disclosure, the particle diameter may mean the average diameter of particles.

In an exemplary embodiment, the tea powder may have a particle diameter of 50 μm or smaller, 1-50 μm, or 10-50 μm.

In an exemplary embodiment, the tea powder may be one in which 99 wt % or more of tea powder based on the total weigh of the processed product of tea has a particle diameter of 75 μm or smaller.

In an exemplary embodiment, the collagen may have a molecular weight of 300-30,000 Mw.

In an exemplary embodiment, the collagen powder may be one which is ingestible and is in powder, and may be derived from pig skin, cow skin or fish.

In an exemplary embodiment, the collagen powder may have a particle diameter of 1-4,000 μm. In another exemplary embodiment, the collagen powder have a particle diameter of 1 μm or larger, 5 μm or larger, 10 μm or larger, 15 μm or larger, 20 μm or larger, 25 μm or larger, 30 μm or larger, 35 μm or larger, 40 μm or larger, 45 μm or larger or 50 μm or larger, and 4,000 μm or smaller, 3,500 μm or smaller, 3,000 μm or smaller, 2,500 μm or smaller, 2,000 μm or smaller, 1,500 μm or smaller, 1,000 μm or smaller, 900 μm or smaller, 800 μm or smaller, 700 μm or smaller, 600 μm or smaller or 500 μm or smaller.

In an exemplary embodiment, the collagen powder may be contained in an amount of 15 wt % or more, 20 wt % or more or 25 wt % or more based on the total weight of the processed product of tea.

In an exemplary embodiment, the collagen powder may be contained in an amount of 15-85 wt %, 20-80 wt % or 25-75 wt % based on the total weight of the processed product of tea.

In an exemplary embodiment, the tea powder and the collagen powder may be contained at a weight ratio of 1-5:5-1, 1-4:4-1 or 1-3:3-1.

In an exemplary embodiment, the tea powder and the collagen powder may have the form of tea-collagen complex particles by adhering to each other. In the present disclosure, the tea-collagen complex particles refer to the particles formed from physical binding, aggregation or cohesion of tea powder and collagen powder, wherein the tea powder and the collagen powder are complexed with each other. The tea-collagen complex particles are quickly wetted and dispersed in water, and this effect is remarkably superior as compared to that of a simple mixture of tea powder and collagen powder. In addition, the tea-collagen complex particles provide an effect of reducing and/or improving the characteristic unpleasant bad taste and bad odor of collagen.

In an exemplary embodiment, the tea-collagen complex particles may be formed with a fluidized-bed granulator.

In an exemplary embodiment, the processed product of tea may be one in which the tea powder is aggregated using the collagen powder as a binder.

In an exemplary embodiment, the processed product of tea may be one prepared by using tea powder, collagen powder and water only.

In an exemplary embodiment, the processed product of tea may be one prepared by spraying water to tea powder and collagen powder.

In an exemplary embodiment, the processed product of tea may consist only of tea powder and collagen powder, without containing other additives such as a binder, a sweetener, a flavor, etc.

In an exemplary embodiment, the processed product of tea may consist of 90 wt % or more or 95 wt % or more of tea powder and collagen powder based on the total weight of the processed product of tea.

The existing fine granule or granule particle has the problem of turbid color, unpleasant aftertaste, etc. occurring when dispersed or dissolved in water, because it is prepared by spraying a solution of a binder dissolved in water to green tea powder. However, since the processed product of tea according to the present disclosure can be prepared without using ingredients that may hinder preference such as a binder, a sweetener, a flavor, etc., it may provide improved preference. In addition, it also provides the advantage of a simplified preparation process.

In the present disclosure, the sweetener refers to a substance which improved taste or flavor by reducing bad taste or bad odor. For example, the sweetener may be a substance added to reduce the characteristic bad taste or bad odor of collagen. The sweetener may be a natural sweetener or an artificial sweetener, and includes a flavor or other food additives which may serves as a sweetener. Examples of the sweetener may include stevia, sucrose, glucose, maltose, oligosaccharide, dextrin, α-cyclodextrin, β-cyclodextrin, γ-cyclodextrin, hydroxypropyl-β-cyclodextrin, indigestible maltodextrin, inverted sugar, fructose, lactose, galactose, starch syrup, sorbitol, maltitol, xylitol, erythritol, mannitol, trehalose, aspartame, sucralose, acesulfame K, saccharin, etc.

In an exemplary embodiment, the processed product of tea may contain fine powder in an amount of 10 wt % or less, 1-10 wt % or 5-10 wt % based on the total particle weight of the processed product of tea, and the fine powder may have a particle diameter or 75 μm or smaller or 1-75 μm.

In an exemplary embodiment, the processed product of tea may have an average diameter of entire particles of 100-600 μm. In another exemplary embodiment, the processed product of tea may have an average diameter of entire particles of 100 μm or larger, 150 μm or larger, 200 μm or larger, 250 μm or larger or 300 μm or larger, and 600 μm or smaller, 550 μm or smaller, 500 μm or smaller, 450 μm or smaller, 400 μm or smaller, 350 μm or smaller or 300 μm or smaller.

In an exemplary embodiment, the processed product of tea may exhibit a wetting time of 60 seconds or shorter, 50 seconds or shorter, 40 seconds or shorter, 30 seconds or shorter, 20 seconds or shorter, 10 seconds or shorter or shorter than 10 seconds when contacted with water, wherein the wetting time is the time required for 2 g of the processed product of tea placed on water surface to sink entirely below water surface. The wetting time may refer to the time it takes for the whole processed product of tea to be immersed in water when 2 g of the processed product of tea is left on the water surface at room temperature without any physical or chemical treatment.

In an exemplary embodiment, the amount of the water may be 500 mL.

In an exemplary embodiment, the wetting time may be the time required for 2 g of the processed product of tea placed on water surface at 15-25° C. to sink entirely below water surface.

In an exemplary embodiment, the processed product of tea may be a fine granule, a powder or a granule.

In an exemplary embodiment, the processed product of tea may be filled in a capsule or a stick-type packet.

In an exemplary embodiment, the processed product of tea may be further processed into an effervescent tablet, a dispersible tablet, etc.

In an exemplary embodiment, the processed product of tea may be directly added to water, juice, etc. for drinking or may be sprayed onto vegetable or fruit salad for ingestion.

The processed product of tea according to the present disclosure should have good wettability and dispersibility (spreadability of particles). The processed product of tea of the present disclosure has so fast dispersibility that it does not require stirring or shaking for dispersion in water, unlike the existing green tea powder or granule. In addition, the processed product of tea does not adhere or aggregate with each other after dispersion in water due to superior redispersibility and maintains the dispersed state for a long time. The processed product of tea exhibits superior dispersibility and redispersibility both in cold and hot water regardless of water temperature.

In addition, the processed product of tea according to the present disclosure has superior flowability or fluidity because the angle of repose is low as 35° or smaller. The angle of repose refers to the steepest angle at which the processed product of tea can be maintained stably. Flowability is decreased as the angle of repose is larger. Accordingly, it provides advantages in the preparation processes of packaging, filling, sealing, etc. (For example, it is easy to package in fixed quantities and fault may be prevented during sealing.) In addition, it is convenient to use because the particles are discharged easily.

In an exemplary embodiment, the method for masking the bad taste or bad odor of collagen may include a step of mixing 25 wt % or more of tea powder based on the total weight of the processed product. In another exemplary embodiment, the method for masking the bad taste or bad odor of collagen may include a step of mixing 25 wt % or more and 90 wt % or less, 85 wt % or less, 80 wt % or less or 75 wt % or less of tea powder based on the total weight of the processed product.

In an exemplary embodiment, in the method for masking the bad taste or bad odor of collagen, tea powder and collagen powder may be mixed at a weight ratio of 1-5:5-1, 1-4:4-1 or 1-3:3-1.

In an exemplary embodiment, in the method for masking the bad taste or bad odor of collagen, a sweetener may not be added.

In an exemplary embodiment, in the method for masking the bad taste or bad odor of collagen, tea-collagen complex particles wherein tea powder and collagen powder are adhered to each other may be prepared.

In an exemplary embodiment, the tea-collagen complex particles may be formed with a fluidized-bed granulator.

In an exemplary embodiment, the tea-collagen complex particles may be prepared by spraying water to tea powder and collagen powder.

The technology disclosed herein include one or more of the following embodiments.

Embodiment 1: a processed product of tea in the form of particles containing tea powder and collagen powder and not containing a binder.

Embodiment 2: the processed product of tea in the form of particles according to the embodiment 1, wherein the tea powder and the collagen powder have the form of tea-collagen complex particles by adhering to each other.

Embodiment 3: the processed product of tea in the form of particles according to the embodiment 1 or the embodiment 2, wherein the tea has one or more of the following properties: i) the tea is tea leaf; ii) the tea is one or more selected from a group consisting of unfermented tea, semi-fermented tea, fermented tea and post-fermented tea; and iii) the tea is green tea.

Embodiment 4: the processed product of tea in the form of particles according to any of the embodiments 1 to 3, wherein the collagen powder is contained in an amount of 15 wt % or more based on the total weight of the processed product of tea.

Embodiment 5: the processed product of tea in the form of particles according to any of the embodiments 1 to 4, wherein the tea powder and the collagen powder are contained at a weight ratio of 1-5:5-1.

Embodiment 6: the processed product of tea in the form of particles according to any of the embodiments 1 to 5, wherein the processed product of tea has an average diameter of entire particles of 100-600 μm.

Embodiment 7: the processed product of tea in the form of particles according to any of the embodiments 1 to 6, wherein the processed product of tea exhibits a wetting time of 60 seconds or shorter when contacted with water, wherein the wetting time is the time required for 2 g of the processed product of tea placed on water surface to sink entirely below water surface.

Embodiment 8: the processed product of tea in the form of particles according to any of the embodiments 1 to 7, wherein the processed product of tea is a fine granule, a powder or a granule.

Embodiment 9: the processed product of tea in the form of particles according to any of the embodiments 1 to 8, wherein the processed product of tea does not contain a sweetener.

Embodiment 10: a processed product of tea in the form of particles, containing tea powder and collagen powder, wherein 10 wt % or less of fine powder is contained based on the total particle weight of the processed product of tea, and wherein the fine powder has a particle diameter of 75 μm or smaller.

Embodiment 11: the processed product of tea in the form of particles according to the embodiment 10, wherein the tea powder and the collagen powder have the form of tea-collagen complex particles by adhering to each other.

Embodiment 12: the processed product of tea in the form of particles according to the embodiment 10 or the embodiment 11, wherein the tea has one or more of the following properties: i) the tea is tea leaf; ii) the tea is one or more selected from a group consisting of unfermented tea, semi-fermented tea, fermented tea and post-fermented tea; and iii) the tea is green tea.

Embodiment 13: the processed product of tea in the form of particles according to any of the embodiments 10 to 12, wherein the collagen powder is contained in an amount of 15 wt % or more based on the total weight of the processed product of tea.

Embodiment 14: the processed product of tea in the form of particles according to any of the embodiments 10 to 13, wherein the tea powder and the collagen powder are contained at a weight ratio of 1-5:5-1.

Embodiment 15: the processed product of tea in the form of particles according to any of the embodiments 10 to 14, wherein the processed product of tea has an average diameter of entire particles of 100-600 μm.

Embodiment 16: the processed product of tea in the form of particles according to any of the embodiments 10 to 15, wherein the processed product of tea exhibits a wetting time of 60 seconds or shorter when contacted with water, wherein the wetting time is the time required for 2 g of the processed product of tea placed on water surface to sink entirely below water surface.

Embodiment 17: the processed product of tea in the form of particles according to any of the embodiments 10 to 16, wherein the processed product of tea is a fine granule, a powder or a granule.

Embodiment 18: the processed product of tea in the form of particles according to any of the embodiments 10 to 17, wherein the processed product of tea does not contain a sweetener.

Hereinafter, the present disclosure will be described in more detail through examples. The examples are described only for the illustration of the present disclosure and it will be obvious to those having ordinary knowledge in the art that the scope of the present disclosure is not limited by the examples.

### Example 1

After adding 375 g of green tea powder (Osulloc Farm, Korea) and 125 g of collagen powder (Seoheung, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-collagen complex particles were obtained by passing the granule through 18-mesh (1,000 μm) sieve.

### Example 2

After adding green 125 g of tea powder (Osulloc Farm, Korea) and 375 g of collagen powder (Seoheung, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-collagen complex particles were obtained by passing the granule through 18-mesh (1,000 μm) sieve.

### Example 3

After adding 250 g of green tea powder (Osulloc Farm, Korea) and 250 g of collagen powder (Seoheung, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-collagen complex particles were obtained by passing the granule through 18-mesh (1,000 μm) sieve.

### Comparative Example 1

After adding 450 g of green tea powder (Osulloc Farm, Korea) and 50 g of collagen powder (Seoheung, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-collagen complex particles were obtained by passing the granule through 18-mesh (1,000 μm) sieve.

### Comparative Example 2

A simple mixture of green tea powder and collagen powder was prepared by mixing 250 g of green tea powder (Osulloc Farm, Korea) and 250 g of collagen powder (Seoheung, Korea) for about 1 minute.

### Comparative Example 3

After adding 500 g of green tea powder (Osulloc Farm, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-green tea complex particles were obtained by passing the granule through 18-mesh (1,000 μm) sieve.

250 g of the obtained green tea-green tea complex particles were mixed with 250 g of collagen powder (Seoheung, Korea) for use as Comparative Example 3.

### Comparative Example 4

After adding 475 g of green tea powder (Osulloc Farm, Korea) to a top-spray fluidized-bed granulator (GPCG-1, Top-spray type, Glatt, Germany), a granule was prepared by spraying 25 g of maltodextrin dissolved in water under the condition of supply air temperature 70° C., exhaust temperature 30±5° C., nozzle inner diameter 1.0 mm, spray pressure 1.0 bar, air flap 25-35% and drying temperature 70° C. Green tea-green tea complex particles were obtained by passing the granule through 18-mesh (1,000 μm) sieve.

### Comparative Example 5

After adding 475 g of green tea powder (Osulloc Farm, Korea) to a top-spray fluidized-bed granulator (GPCG-1, Top-spray type, Glatt, Germany), a granule was prepared by spraying 25 g of hydroxypropylmethyl cellulose (HPMC, 4 cps, Lotte Fine Chemical, Korea) dissolved in water under the condition of supply air temperature 70° C., exhaust temperature 30±5° C., nozzle inner diameter 1.0 mm, spray pressure 1.0 bar, air flap 25-35% and drying temperature 70° C. Green tea-green tea complex particles were obtained by passing the granule through 18-mesh (1,000 μm) sieve.

### Comparative Example 6

500 g of green tea powder (Osulloc Farm, Korea) was used as Comparative Example 6.

### Comparative Example 7

After adding 50 g of green tea powder (Osulloc Farm, Korea) and 450 g of collagen powder (Seoheung, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-collagen complex particles were obtained by passing the granule through 18-mesh (1,000 μm) sieve.

### Comparative Example 8

500 g of collagen powder (Seoheung, Korea) was used as Comparative Example 8.

### Comparative Example 9

After adding 125 g of a green tea extract in powder form (Samkyung Costech, Korea) and 375 g of collagen powder (Seoheung, Korea) to a top-spray fluidized-bed granulator (GPCG-1, Top-spray type, Glatt, Germany), a granule was prepared by spraying water under the condition of supply air temperature 70° C., exhaust temperature 30±5° C., nozzle inner diameter 1.0 mm, spray pressure 1.0 bar, air flap 25-35% and drying temperature 70° C. Green tea-collagen complex particles were obtained by passing the granule through 18-mesh (1,000 μm) sieve.

### Test Example

(1) Particle Size Analysis

For the processed products of tea of Examples 1-3 and Comparative Examples 1-6, the content of fine powder having a specific particle size (75 μm or smaller) was measured using a particle size analyzer (Mastersizer, Malvern, England), and the result is shown in Table 1. When 500 g of collagen powder (Seoheung, Korea) was used, the content of fine powder was 25.67 wt %.

(2) Measurement of Wetting Time

After cautiously adding 2 g of the processed product of tea of Examples 1-3 or Comparative Examples 1-6 to a beaker containing 500 mL of water at room temperature, wetting time, i.e., the time required for the processed product to settle down, was measured, and the result is shown in Table 1. The wetting time is the time required for the entire processed product of tea to sink entirely below water surface without applying physical force such as stirring or shaking. The maximum time of observation was set to 180 seconds because some samples continued to remain on the water surface without settling down.

(3) Measurement of Angle of Repose

The processed product of tea of Examples 1-3 or Comparative Examples 1-6 was poured through a funnel and the funnel was lifted slowly to form a cone. The average values of the diameter and height of the piled cone were measured at four points and the angle of repose was calculated from the following equation. The result is shown in Table 1.

tan α=height/(0.5×base diameter)

The angle of repose is a measure of the fluidity (flowability) of particles: 25-30° very good, 31-35° good, 36-40° slightly good. As the fluidity is superior, it is easier to fill a desired amount of particles or capsules in a stick packet.

TABLE 1

| | | | | Comp. | Comp. | Comp. | Comp. | Comp. | Comp. |
|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 |
| Green tea- | 500 | 500 | 500 | 500 | | | | | |
| collagen | | | | | | | | | |
| complex | | | | | | | | | |
| particles (g) | | | | | | | | | |
| Green tea- | | | | | | 250 | 475 | 475 | |
| green tea | | | | | | | | | |
| complex | | | | | | | | | |
| particles (g) | | | | | | | | | |
| Green tea | | | | | 250 | | | | 500 |
| powder (g) | | | | | | | | | |
| Collagen | | | | | 250 | 250 | | | |
| powder (g) | | | | | | | | | |
| Binder (g) | X | X | X | X | X | X | Maltodextrin | HPMC | X |
| | | | | | | | 25 | 25 | |
| Wetting time | 10> | 10> | 10> | 180< | 180< | 180< | 180< | 18 | 180< |
| (sec) | | | | | | | | | |
| Fine powder (75 | 6.81 | 9.84 | 7.57 | 53.1 | 75.99 | 47.01 | 58.09 | 23.09 | 99.52 |
| μm ≥) content | | | | | | | | | |
| (%) | | | | | | | | | |
| Angle of repose | 31.7 | 33.0 | 32.3 | 37.2 | 51.1 | 36.9 | 34.9 | 35.4 | 53.4 |
| (°) | | | | | | | | | |

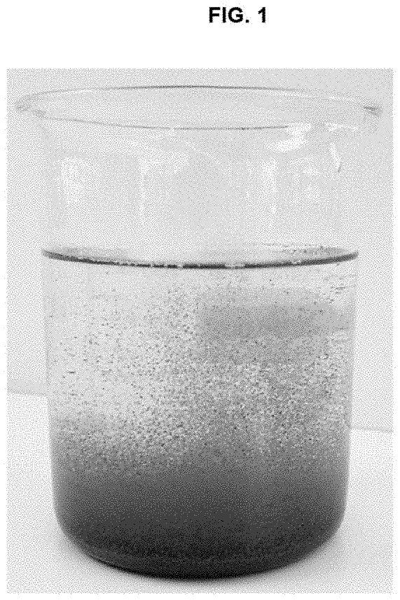

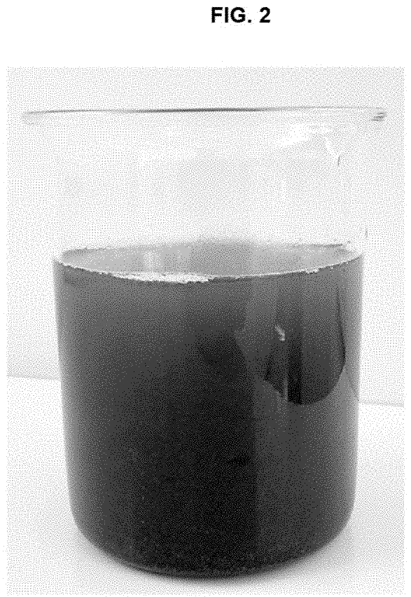

In Examples 1-3, the processed products of tea were prepared from green tea-collagen complex particles by mixing 25-75 wt % of green tea powder with 25-75 wt % of collagen powder. It was confirmed that the processed products of tea of Examples 1-3 had a fine powder content of 10 wt % or less and a very superior dispersion rate in water with a wetting time of shorter than 10 seconds (see FIG. 1). It was confirmed that the processed products of tea of Examples 1-3 are dispersed quickly in water and exhibit superior redispersibility after being dispersed in water without adhesion or aggregation (see FIG. 2). Green tea powder or granule may remain aggregated without being dispersed well even after being dispersed. However, it was confirmed that the processed product of tea according to the present disclosure showed very superior dispersibility despite the absence of a binder and showed little aggregation despite the absence shaking or stirring.

In addition, it was confirmed that the processed products of tea of Examples 1-3 had good fluidity, with an angle of repose of 35° or smaller. The processed products of tea of Examples 1-3 showed better fluidity than the processed products of tea of Comparative Examples 4-5 wherein binders were used. Accordingly, it was confirmed that the processed product of tea according to the present disclosure has advantages in terms of easy product packaging during filling, etc. and easy discharge of particles due to good fluidity.

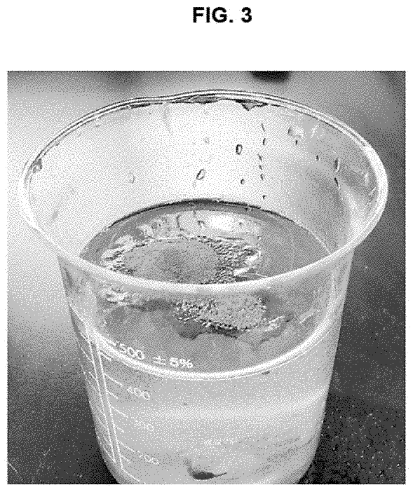

In Comparative Example 1, green tea-collagen complex particles were prepared using 450 g of green tea powder and 50 g of collagen powder. It was confirmed that the processed product of tea of Comparative Example 1 had a high fine powder content and showed poor dispersibility in water, with a considerable amount of particles remaining on water surface without being wetted during the measurement time (180 seconds) (see FIG. 3). It is thought that the low content of collagen powder decreases binding force to the tea powder, thus increasing the fine powder content and lowering dispersibility in water.

Comparative Example 2, which is a simple mixture of green tea powder and collagen powder, showed high fine powder content and long wetting time.

In Comparative Example 3, a granule was prepared from green tea powder only and it was mixed with collagen powder of the same amount. The processed product of tea of Comparative Example 3, which contain green tea-green tea complex particles, showed increased fine powder content due to the simply added collagen powder, and the dispersibility of green tea powder in water was not improved.

In Comparative Examples 4-5, green tea-green tea complex particles were prepared by using maltodextrin or HPMC as a binder. The processed product of tea of Comparative Example 4 could not improve the dispersibility of green tea powder in water despite the use of the binder. The processed product of tea of Comparative Example 5, wherein HPMC was used as a binder, showed relatively fast wetting property although the fine powder content was high. However, it showed slower wetting rate when compared with the processed product of tea according to the present disclosure. In addition, the processed product of tea of Comparative Example 5 had the problem of unpleasant aftertaste, etc. HPMC is a synthetic additive which does not meet the standard of clean label and has poor consumer preference.

Comparative Example 6, which is a green tea powder with a fine powder content of 99.52 wt %, was found to be aggregated without being dispersed well when the green tea powder was mixed with water for drinking.

(4) Dispersibility of Microcrystalline Cellulose

For microcrystalline cellulose (Avicel PH200, DuPont, USA), which is a commercially available crystalline powder, the content of fine powder having a particle diameter of 75 μm or smaller was measured using a particle size analyzer (Mastersizer, Malvern, England). As a result, the microcrystalline cellulose powder had a fine powder content of 9.29%.

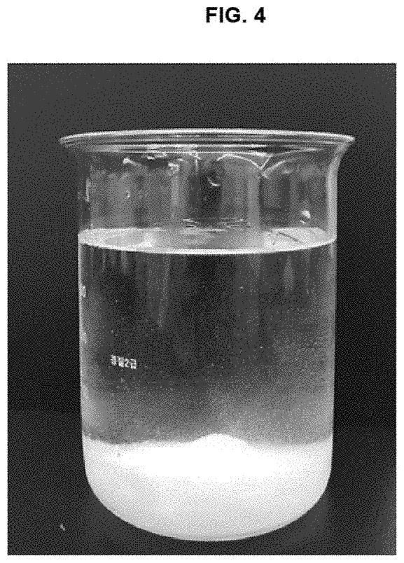

In addition, after cautiously adding microcrystalline cellulose powder to a beaker containing 500 mL of water at room temperature, dispersion state was observed 20 seconds later without applying physical force such as stirring or shaking. As a result, it was confirmed that the microcrystalline cellulose was not dispersed well in water but settled down entirely 20 seconds later (see FIG. 4).

Since the microcrystalline cellulose showed low dispersibility and redispersibility in water although it had a small fine powder content, it can be seen that the fine powder content is not the factor that determines the dispersibility of particles and that different dispersibility and redispersibility may be exhibited depending on particles even when the fine powder content is small.

(5) Evaluation of Preference for Bad Taste and Bad Odor of Collagen

The preference for taste and odor and overall preference were evaluated for the particles of Examples 1-3 and the particles of Comparative Examples 7-9 for 10 panels. Specifically, after asking the panels to drink 1 g of each particle dispersed in 150 mL of water, the preference for bad taste and bad odor of collagen and overall preference were evaluated. A result of averaging the evaluation scores is shown in Table 2. The highest score was set to 15 points, and the higher score means better preference for taste and odor and overall preference.

TABLE 2

| | | | | Comp. | Comp. | Comp. |
|---|---|---|---|---|---|---|
| | Ex. 1 | Ex. 2 | Ex. 3 | Ex. 7 | Ex. 8 | Ex. 9 |
| Green tea-collagen | 500 | 500 | 500 | 500 | | 500 |
| complex | | | | | | |
| particles (g) | | | | | | |
| Collagen powder (g) | | | | | 500 | |
| Preference for taste | 14.3 | 7.2 | 13.7 | 4.5 | 2.5 | 3.2 |
| Preference for odor | 13.8 | 6.8 | 12.8 | 5.9 | 2.1 | 7.1 |
| Overall preference | 14.2 | 7.8 | 13.1 | 4.3 | 1.9 | 4.2 |

As shown in Table 2, by using the green tea powder, the bad taste and bad odor of collagen could be reduced significantly and the overall preference could be improved greatly even without using a sweetener. In particular, it was confirmed that a content of the green tea powder of 25 wt % or more based on the total weight of the processed product was more effective in improving the bad taste and bad odor of collagen. In addition, for Example 2, wherein the green tea powder was 25 wt % based on the total weight of the processed product, the preference for taste was about 2 times as compared to Comparative Example 9, wherein a green tea extract in powder form was used instead of the green tea powder of the same content. Accordingly, it was confirmed that the green tea powder is very effective in improving the bad taste and bad odor of collagen.

Although the specific exemplary embodiments of the present disclosure have been described in detail above, it will be obvious to those having ordinary knowledge in the art that they are merely preferred exemplary embodiments and the scope of the present disclosure is not limited thereby. Accordingly, the substantial scope of the present disclosure is defined by the appended claims and their equivalents.

1. A processed product of tea in the form of particles, comprising tea powder and collagen powder and not comprising a binder.

2. The processed product of tea in the form of particles according to claim 1, wherein the tea powder and the collagen powder have the form of tea-collagen complex particles by adhering to each other.

3. The processed product of tea in the form of particles according to claim 1, wherein the tea has one or more of the following properties:
i) the tea is tea leaf;
ii) the tea is one or more selected from a group consisting of unfermented tea, semi-fermented tea, fermented tea and post-fermented tea; and
iii) the tea is green tea.

4. The processed product of tea in the form of particles according to claim 1, wherein the collagen powder is comprised in an amount of 15 wt % or more based on the total weight of the processed product of tea.

5. The processed product of tea in the form of particles according to claim 1, wherein the tea powder and the collagen powder are comprised at a weight ratio of 1-5:5-1.

6. The processed product of tea in the form of particles according to claim 1, wherein the processed product of tea has an average diameter of entire particles of 100-600 μm.

7. The processed product of tea in the form of particles according to claim 1, wherein the processed product of tea exhibits a wetting time of 60 seconds or shorter when contacted with water, wherein the wetting time is the time required for 2 g of the processed product of tea placed on water surface to sink entirely below water surface.

8. The processed product of tea in the form of particles according to claim 1, wherein the processed product of tea is a fine granule, a powder or a granule.

9. The processed product of tea in the form of particles according to claim 1, wherein the processed product of tea does not comprise a sweetener.

10. A processed product of tea in the form of particles, comprising tea powder and collagen powder,
wherein 10 wt % or less of fine powder is comprised based on the total particle weight of the processed product of tea, and
wherein the fine powder has a particle diameter of 75 μm or smaller.

11. The processed product of tea in the form of particles according to claim 10, wherein the tea powder and the collagen powder have the form of tea-collagen complex particles by adhering to each other.

12. The processed product of tea in the form of particles according to claim 10, wherein the tea has one or more of the following properties:
i) the tea is tea leaf;
ii) the tea is one or more selected from a group consisting of unfermented tea, semi-fermented tea, fermented tea and post-fermented tea; and
iii) the tea is green tea.

13. The processed product of tea in the form of particles according to claim 10, wherein the collagen powder is comprised in an amount of 15 wt % or more based on the total weight of the processed product of tea.

14. The processed product of tea in the form of particles according to claim 10, wherein the tea powder and the collagen powder are comprised at a weight ratio of 1-5:5-1.

15. The processed product of tea in the form of particles according to claim 10, wherein the processed product of tea has an average diameter of entire particles of 100-600 μm.

16. The processed product of tea in the form of particles according to claim 10, wherein the processed product of tea exhibits a wetting time of 60 seconds or shorter when contacted with water, wherein the wetting time is the time required for 2 g of the processed product of tea placed on water surface to sink entirely below water surface.

17. The processed product of tea in the form of particles according to claim 10, wherein the processed product of tea is a fine granule, a powder or a granule.

18. The processed product of tea in the form of particles according to claim 10, wherein the processed product of tea does not comprise a sweetener.
